(19) United States
(12) Patent Application Publication
(10) Pub. No.: US 2020/0232885 A1
(43) Pub. Date: Jul. 23, 2020

(54) RELIABILITY EVALUATION METHOD FOR CNC MACHINE TOOLS BASED ON BAYES AND FAULT TREE

(71) Applicant: Dalian University of Technology, Dalian City (CN)

(72) Inventors: Kuo LIU, Dalian City (CN); Yongqing WANG, Dalian City (CN); Jiakun WU, Dalian City (CN); Haoqi DONG, Dalian City (CN); Te LI, Dalian City (CN); Haibo LIU, Dalian City (CN)

(21) Appl. No.: 16/481,035

(22) PCT Filed: Aug. 28, 2018
(86) PCT No.: PCT/CN2018/102609

§ 371 Date: Jul. 25, 2019

(51) Int. Cl. G01M 99/00; G05B 19/4155

(52) U.S. Cl. CPC G01M 99/005; G05B 2219/33099; G05B 19/4155

(57) ABSTRACT

A reliability evaluation method for CNC machine tools based on Bayes and fault tree, belongs to the technical field of reliability evaluation for CNC machine tools. First, the CNC machine tool is regarded as a system composed of subsystems, and the subsystem fault data of the same production batch is used as the prior information. Next, the joint probability density function of the failure rate of each failure subsystem is used as the likelihood function of the field data, and the logarithmic inverse Gamma distribution is used as the conjugate prior distribution of the reliability. Based on this, the joint prior distribution probability density function of Weibull distribution size and shape parameters is determined Finally, the fault tree model is established. This can increase the sample size of the prior information, eliminate the complicated sample compatibility test, and ensure the compatibility of the prior information.

### TECHNICAL FIELD

The invention belongs to the technical field of reliability evaluation for CNC machine tools, and specifically relates to a reliability evaluation method for CNC machine tools based on Bayes and fault tree.

### BACKGROUND

Reliability is an important performance index for CNC (computer numerical control) machine tools, so reliability evaluation is an important part of their performance evaluation. High-quality CNC machine tools have the characteristics of few fault samples, so the evaluation based on small sample data is the focus of current high-quality CNC machine tool reliability research.

Since there is no uniform standard for the reliability evaluation method of CNC machine tools existing, and evaluation based on small sample fault data is difficult, it is very important to find a reasonable and effective small sample data reliability evaluation theory.

As an important statistics theory, the Bayes method can consider the prior information to analyze small sample data and obtain convincing estimation results, making up for the weakness of classical statistics. However, the determination of the prior distribution is highly subjective and arbitrary, especially when the prior distribution is completely unknown or partially unknown, the Bayes solution is of poor quality. For high reliability CNC machine tools, since the sample size of prior information is too different from that of field test sample, it is difficult to make a compatibility assessment. In addition, the selection of prior information is very difficult, which coupled with the lack of posterior information, leads to bad prior information with a high impact on the accuracy of the results. The evaluation results of the Bayes method, as used directly on high-reliability CNC machine tools, often deviate significantly from the actual use.

At present, there are some scholars who have studied the reliability evaluation method for high reliability CNC machine tools based on Bayes theory. However, when Bayes theory is applied to solve the reliability evaluation problem of CNC machine tools, the CNC machine tool is still treated as a whole part.

### SUMMARY

The present invention mainly solves the problem of reliability evaluation based on small sample for CNC machine tools, where it is difficult to select reasonable prior information or to test the compatibility between prior and posterior information. With the rapid development of CNC machine tools, the functions are continuously enhanced, while the level of reliability is increasing. High reliability CNC machine tools have few fault data, while the prior information is difficult to select. Therefore, it is of practical engineering significance to study a method that solves the problem of reliability evaluation for high reliability CNC machine tools.

The technical solution of the invention: A reliability evaluation method for CNC machine tools based on Bayes and fault tree, comprises following steps:

(1) Selection of Prior Information

The prior history fault data of the same subsystem is used as prior information, while the Weibull distribution is used to fit the distribution:

$$R ( t ) = 1 - F ( t ) = {e}^{- {( \frac{t}{λ} )}^{k}} \qquad ( 1 )$$

Where, e is a natural constant, t is the fault interval time or working life, R(t) is the reliability distribution function, λ is the size parameter, k is the shape parameter, and F(t) is the cumulative failure probability function.

The reliability distribution function of the CNC machine tool subsystem is obtained by Eq.(1).

(2) Calculation of Prior Distribution

For the reliability R_{τ} at a given task time τ, the logarithmic inverse Gamma distribution is chosen as its prior distribution, and the prior distribution of subsystem reliability is:

$$π ( {R}_{τ} ) = \frac{{b}^{a}}{Γ ( a )} {{R}_{τ}^{b - 1} [ ln ( \frac{1}{{R}_{τ}} ) ]}^{a - 1} \qquad ( 2 )$$

Where, a and b are hyperparameters, greater than zero;

R_{τ} is expressed as the form of mean and variance. The specific values of mean and variance are estimated by the reliability distribution function, which is based on prior information. In Eq.(2) of the prior distribution of reliability, the mean and variance are respectively obtained from the formula of the logarithmic inverse Gamma distribution:

$$\begin{matrix}{\hat{μ}}_{R} = {( \frac{b}{b + 1} )}^{a} & ( 3 ) \\ {\hat{σ}}_{R}^{2} = {( \frac{b}{b + 2} )}^{a} - {( \frac{b}{b + 1} )}^{2 a} & ( 4 )\end{matrix}$$

From the equations (3) and (4), the values of the two parameters a and b, in the reliability prior distribution, are obtained, as well as the reliability prior distribution of the determined parameters.

(3) Determination of the Prior Distribution of Size and Shape Parameters

The shape parameter k is regarded as a prior distribution without information, where the following formula applies:

π(k)∝k⁻¹,k≥0 (5)

A common prior distribution without information: uniform distribution is used to represent the prior distribution of shape parameters.

$$π ( k ) = \frac{1}{{k}_{2} - {k}_{1}} , {k}_{1} \leq k \leq {k}_{2} \qquad ( 6 )$$

According to Eq.(2) and Eq.(6), the conditional prior distribution of size parameter λ is obtained, when the shape parameter k is given:

$$π ( λ \vert k ) = \frac{{b}^{a}}{Γ ( a )} \frac{k}{λ} {( \frac{τ}{λ} )}^{ka} {e}^{( - {b ( \frac{τ}{λ} )}^{k} )} \qquad ( 7 )$$

(4) Calculation of Reliability Posterior Distribution and Reliability Mean

For the subsystem failure data of the field reliability test: t₁, t₂, t₃ . . . tₘ,

$${X}^{( k )} = {\sum }_{i = 1}^{m} {t}_{i}^{k} , U = {\prod }_{i = 1}^{m} {t}_{i} ,$$

the likelihood function, which uses the field reliability test data as a sample, is:

$$L ( D \vert k , λ ) = {k}^{m} {λ}^{- m k} {U}^{k - 1} {e}^{( - \frac{{X}^{( k )}}{{λ}^{k}} )} \qquad ( 8 )$$

Where, D is the field reliability test data.

According to Bayes theory, the joint posterior distributions of k and λ are obtained by combining Eqs. (2), (6), (7) and (8):

$$π ( k , λ \vert D ) = \frac{{k}^{m + 1} {τ}^{k a} {λ}^{- ( m + a ) k - 1} {U}^{k - 1} {e}^{( - \frac{{X}^{( k )} + b {τ}^{k}}{{λ}^{k}} )}}{Γ ( m + a ) I ( D )} \qquad ( 9 )$$

Where, I(D) is:

$$I ( D ) = {\int }_{K} \frac{{k}^{m} {τ}^{ka} {U}^{k - 1}}{{( {X}^{( k )} + b {τ}^{k} )}^{( m + a )}} dk , k ∈ K \qquad ( 10 )$$

Combining Eqs.(1) and (9), the posterior distribution of the reliability R of the known field reliability test data is:

$$\begin{matrix}π ( R \vert D ) = \frac{1}{Γ ( m + a ) I ( D )} \frac{{[ ln ( \frac{1}{R} ) ]}^{a + m - 1}}{R} {\int }_{K} \frac{{k}^{m} {τ}^{ka} {U}^{k - 1} {R}^{( \frac{{X}^{( k )} + b {τ}^{k}}{{τ}^{k}} )}}{{τ}^{k 〈 m + a )}} dk , & ( 11 ) \\ k ∈ K & \end{matrix}$$

Then, the expected value is calculated by Eq.(11), while the mean reliability is obtained as:

$$\begin{matrix}E ( {R}_{τ} ) = {\int }_{0}^{1} {R}_{τ} \times π ( {R}_{τ} \vert D ) d R = \frac{1}{I ( D )} {\int }_{K} \frac{{k}^{m} {τ}^{ka} {U}^{k - 1}}{{[ {X}^{( k )} + ( b + 1 ) {τ}^{k} ]}^{( m + a )}} dk , & ( 12 ) \\ k ∈ K & \end{matrix}$$

(5) Establishment of Fault Tree Model for CNC Machine Tools

The CNC machine tool is regarded as a complex system, composed of CNC system, servo system, spindle system, feed axis system, cooling and lubrication system, motor and power supply. Based on the series-parallel relationship among the subsystems and the influence of subsystems on the machine tool system, the fault tree model is established, regarding the fault event of CNC machine tool as the top event.

(6) Calculation of Reliability of CNC Machine Tools

By replacing the “AND gate” with “OR gate” and the “OR gate” with “AND gate” in the fault tree model, and the occurrence of all events is changed into non-occurring, the success tree of the CNC machine tool is obtained.

Only normal and failure states are considered for all events, and steady-state processing is treated without considering the time variation.

The minimum path set of reliable tree is Kᵢ(X) and its structural formula is:

$${K}_{i} ( X ) = 1 - {\prod }_{j ⊆ {k}_{i}} ( 1 - {X}_{j} ) \qquad ( 13 )$$

Where, kᵢ is a subscript set of basic events, included in the minimum path set Kᵢ(X);

The structural formula of the top event, represented by the minimum path set is:

$$T = {\prod }_{i} {K}_{i} ( X ) \qquad ( 14 )$$

By substituting reliability into the formula, the reliability calculation equationof CNC machine tools is obtained as:

$$E ( {R}_{τ}^{T} ) = {\prod }_{i} ( 1 - {\prod }_{j ⊆ {k}_{i}} ( 1 - {E}_{j} ( {R}_{τ}^{j} ) ) ) \qquad ( 15 )$$

Where E(R^{T}_{τ}) is the mathematical expectation of the reliability of CNC machine tools, and Eⱼ(R^{j}_{τ}) is the mathematical expectation of the reliability of the j^{th} subsystem.

Furthermore, the reliability of the CNC machine tool is obtained by the calculation of reliability, as expressed by Eq. (15).

The beneficial effects of the invention:

(1) The present invention uses the fault data of the same subsystem as prior information, thus increasing the sample size of the prior information, while eliminating the complicated sample compatibility test and ensuring the compatibility of the prior information.

(2) In the process of determining the prior distribution of reliability, the present invention comprehensively considers the statistical feature quantity in the prior information, thus reducing the influence of subjective factors on the selection of the prior distribution form.

(3) The invention first calculates the reliability of each subsystem through Bayes theory, and then obtains the reliability of the CNC machine tool through the fault tree, so that the evaluation result is also in conformity with the nature of Bayes statistical results. Due to the accurate application of prior information, not only the shortcomings of the fault data samples are compensated for, but also the Bayes solution is good.

### DRAWINGS

FIG. 1 Fault tree diagram of a CNC machine tool.

FIG. 2 Success tree diagram of the CNC machine tool.

### DETAILED DESCRIPTION

In order to make the technical solutions and advantageous effects of the present invention more clear, a detailed description of the present invention in conjunction with a specific reliability evaluation process and with reference to the accompanying drawings is as follows. The present embodiment is carried out on the premise of the technical solution of the present invention, along with detailed implementation method and specific operation procedures. However, the scope of protection of the present invention is not limited to the following embodiments.

(1) Selection of Prior Information

Consider the case where a total of 7 failures occurred in the reliability test of the CNC machine tool, among which, 4 failures are spindle subsystem failures, 2 failures are cooling subsystem failures, and 1 failure is limit switch compression failure. Next, the fault data of the spindle subsystem of the same production batch is selected as the prior information for the spindle subsystem; the fault data of the cooling subsystem of the same production batch is selected as the prior information for the cooling subsystem; the fault data of the limit switch subsystem of the same production batch is selected as the prior information for the limit switch subsystem. Their distribution parameters, under the Weibull distribution, are estimated by the maximum likelihood method.

The prior fault data of the spindle subsystem are shown in Table 1.

TABLE 1
Prior Fault Data of Spindle Subsystem

| Fault number | Continuous fault-free time |
|---|---|
| 1 | 941 |
| 2 | 978 |
| 3 | 443 |
| 4 | 885 |
| 5 | 1165 |
| 6 | 557 |
| 7 | 1142 |
| 8 | 865 |
| 9 | 685 |
| 10 | 971 |
| 11 | 704 |
| 12 | 1064 |
| 13 | 955 |
| 14 | 727 |
| 15 | 876 |
| 16 | 1027 |
| 17 | 807 |
| 18 | 967 |
| 19 | 857 |
| 20 | 622 |
| 21 | 753 |
| 22 | 471 |
| 23 | 907 |
| 24 | 916 |
| 25 | 925 |
| 26 | 931 |
| 27 | 332 |
| 28 | 947 |
| 29 | 721 |
| 30 | 824 |
| 31 | 691 |
| 32 | 390 |
| 33 | 985 |
| 34 | 995 |
| 35 | 781 |
| 36 | 718 |
| 37 | 1133 |
| 38 | 606 |
| 39 | 1154 |
| 40 | 496 |

The prior distribution of the spindle subsystem is calculated as follows:

$$R ( t ) = 1 - F ( t ) = {e}^{- {( \frac{t}{901.9625} )}^{4.6624}} \qquad ( 16 )$$

(2) Calculation of Prior Distribution

For the reliability R_{τ} at a given task time τ, the logarithmic inverse Gamma distribution is chosen as its prior distribution, and the prior distribution of subsystem reliability is shown in Eq. (2). For the spindle subsystem, the method of estimating the mean and variance of the prior distribution of the parameters from the prior information is as follows: If the fault-free operational time of the spindle subsystem should be 825 hours, the reliability function obtained from the prior information can determine the reliability of similar products at 825 hours is 0.52. Since compared with similar product in the prior information, the new product is usually improved, thus it can be considered that there is still room for improvement of the reliability, which determined by experience is generally reaching a maximum of 0.94. The interval of determined reliability is [0.52, 0.94], that is, the average value can be taken as 0.73, while the variance can be obtained by the principle of 3σ, providing a value of 0.0049.

After obtaining the mean and variance and substituting them into Eqs.(3) and (4), the estimated values of a and b are calculated, while using the logarithm change of base formula to change the above formula, the following equations are derived:

$$\begin{matrix}{( \frac{b}{b + 2} )}^{\frac{ln {\hat{μ}}_{R}}{ln ( \frac{b}{b + 1} )}} - {( \frac{b}{b + 1} )}^{\frac{2 ln {\hat{μ}}_{R}}{ln ( \frac{b}{b + 1} )}} - {\hat{σ}}^{2} = 0 & ( 17 ) \\ a = \frac{ln {\hat{μ}}_{R}}{ln ( \frac{b}{b + 1} )} & ( 18 )\end{matrix}$$

The Eqs. (17) and (18) can approximate the values of the two parameters a and b in the reliability prior distribution, deriving: a=10.5, b=32.9.

The prior probability density function of the reliability at a given task time of 825 hours is shown as follows:

$$π ( {R}_{τ} ) = \frac{32 . {9}^{10.5}}{Γ ( 10.5 )} {{R}_{τ}^{31.9} [ ln ( \frac{1}{{R}_{τ}} ) ]}^{9.5} \qquad ( 19 )$$

(3) Determination of the Prior Distribution of Size and Shape Parameters

A priori random variable such as the shape parameter k, can be treated as a priori distribution without information. For such a distribution, there is Eq. (6), where k₁ and k₂ are calculated by prior data, or set based on experts' experience, and K is referred to the domain [k₁, k₂] for the k. According to the prior information, k₁=2, k₂=8.

The conditional prior distribution of size parameter λ, with the given shape parameter k, can be obtained by transforming the reliability of distribution, according to Eq.(2) and Eq.(6).

(4) Calculation of Reliability Posterior Distribution and Reliability Mean

For the subsystem failure data of the field reliability test:

$${t}_{1} , {t}_{2} , {t}_{3} … {t}_{m} , {X}^{( k )} = {\sum }_{i = 1}^{m} {t}_{i}^{k} , U = {\prod }_{i = 1}^{m} {t}_{i} ,$$

the likelihood function which uses the field data as sample, is shown in Eq.(8). The spindle fault data is considered as an example, where t₁=595, t₂=812, t₃=975, and t₄=983. According to Bayes theory and Eq.(12), the mean reliability of the spindle subsystem is 0.72 when the specified task time is 800 hours. Similarly, the reliability of the limit switch subsystem and the cooling subsystem are calculated as: the reliability of the limit switch subsystem is 0.97, and the reliability of the cooling subsystem is 0.88.

(5) Establishment of Fault Tree Model for CNC Machine Tools

CNC machine tool is a complex system which integrates electrical, mechanical and hydraulic systems. According to their respective functions, these can be divided into CNC system, servo system, spindle system, feed axis system, cooling and lubrication system, motor, power supply and so on.

In the fault tree, the top event is a system-level subsystem of the object being diagnosed. For the fault tree of CNC machine tools, the fault event of CNC machine tools is the top event.

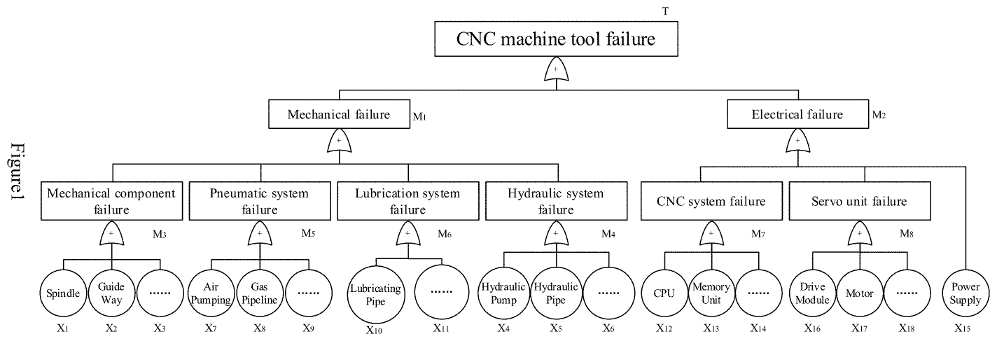

Since the number of zero subsystems of CNC machine tools is very large, in order to simplify the tree-building task, it is necessary to establish boundary conditions to distinguish the events into not allowed, impossible and inevitable. In the process of tree building, we should grasp the main contradictions, high possibility and key failure events. Finally, we get the model of fault tree of CNC machine tools as shown in FIG. 1.

In FIG. 1, T is the top event, M₁, M₂, M₃ . . . are intermediate events, X₁, X₂, X₃ . . . are basic events, also known as bottom events. In order to reduce the computational complexity and tree-building complexity, only the failures having occurred during the time-truncation period of the field reliability test or basic events which are considered by experience is prone to fail and basic events having not failed but relatively destructive are considered in the process of analysis and calculation. Other low failure rate and low hazard subsystems can be considered as their failure rate is close to zero, that is, their reliability is close to 1.

(6) Calculation of Reliability of CNC Machine Tools

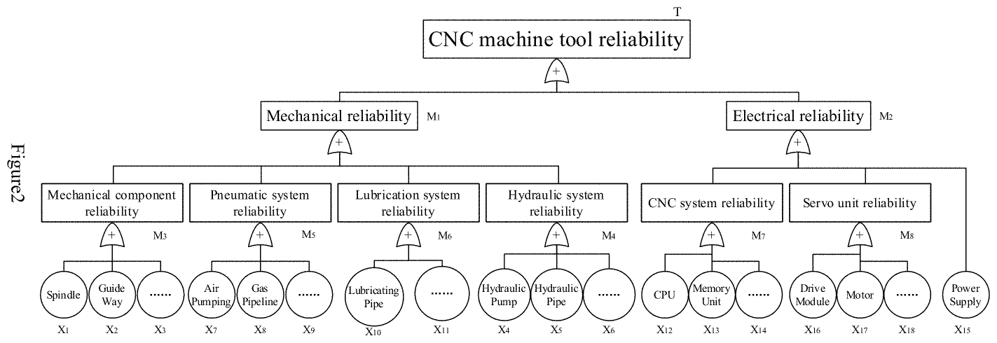

According to the fault tree model, the top event failure rate can be quantitatively analyzed when the basic event failure rate is known. If we want to quantitatively analyze the reliability of top events through the reliability of basic events, the fault tree can be transformed into a success tree. By replacing the “AND gate” of fault tree with “OR gate” and “OR gate” with “AND gate”, and turning occurrences of all events into non-occurrences, the success tree of CNC machine tools is obtained as shown in FIG. 2.

Considering the characteristics of the reliable tree model of CNC machine tools, in order to simplify the analysis, all basic events can be considered as independent of each other. All events are treated as steady state, without considering the time change, only considering the normal and failure states. The reliability of CNC machine tool is calculated to be 0.61 by using the formula of reliability Eq. (15).

It should be noted that the above specific application is only used to illustrate the principles and processes of the present invention by way of example, it does not constitute a limitation to the present invention. Therefore, any modifications and equivalent substitutions made without departing from the idea and scope of the present invention shall be included in the scope of protection of the present invention.

1. A reliability evaluation method for CNC machine tools based on Bayes and fault tree is presented, wherein the following steps are comprised:
(1) selection of prior information
the prior history fault data of the same subsystem is used as prior information, while the Weibull distribution is used to fit the distribution:
$$R ( t ) = 1 - F ( t ) = {e}^{- {( \frac{t}{λ} )}^{k}} \qquad ( 1 )$$
where, e is a natural constant, t is the fault interval time or working life, R(t) is the reliability distribution function, λ is the size parameter, k is the shape parameter, and F(t) is the cumulative failure probability function;
the reliability distribution function of the CNC machine tool subsystem is obtained by equation (1);
(2) calculation of prior distribution
for the reliability R_{τ} at a given task time τ, the logarithmic inverse Gamma distribution is chosen as its prior distribution, and the prior distribution of subsystem reliability is:
$$π ( {R}_{τ} ) = \frac{{b}^{a}}{Γ ( a )} {{R}_{τ}^{b - 1} [ ln ( \frac{1}{{R}_{τ}} ) ]}^{a - 1} \qquad ( 2 )$$
where, a and b are hyperparameters, greater than zero;
R_{τ} is expressed as the form of mean and variance; the specific values of mean and variance are estimated by the reliability distribution function which is based on prior information; in equation (2) of the prior distribution of reliability, the mean and variance are respectively obtained from the formula of the logarithmic inverse Gamma distribution:
$$\begin{matrix}{\hat{μ}}_{R} = {( \frac{b}{b + 1} )}^{a} & ( 3 ) \\ {\hat{σ}}_{R}^{2} = {( \frac{b}{b + 2} )}^{a} - {( \frac{b}{b + 1} )}^{2 a} & ( 4 )\end{matrix}$$
from the equations (3) and (4), the values of the two parameters a and b, in the reliability prior distribution, are obtained, as well as the reliability prior distribution of the determined parameters;
(3) determination of the prior distribution of size and shape parameters
the shape parameter k is regarded as a prior distribution without information, where the following equation applies:
π(k)∝k⁻¹,k≥0 (5)
a common prior distribution without information: uniform distribution is used to represent the prior distribution of shape parameters:
$$π ( k ) = \frac{1}{{k}_{2} - {k}_{1}} , {k}_{1} \leq k \leq {k}_{2} \qquad ( 6 )$$
according to equation (2) and equation. (6), the conditional prior distribution of size parameter λ is obtained, when the shape parameter k is given:
$$π ( λ \vert k ) = \frac{{b}^{a}}{Γ ( a )} \frac{k}{λ} {( \frac{τ}{λ} )}^{ka} {e}^{( - {b ( \frac{τ}{λ} )}^{k} )} \qquad ( 7 )$$
(4) calculation of reliability posterior distribution and reliability mean
for the subsystem failure data of the field reliability test:
$${t}_{1} , {t}_{2} , {t}_{3} … {t}_{m} , {X}^{( k )} = {\sum }_{i = 1}^{m} {t}_{i}^{k} , U = {\prod }_{i = 1}^{m} {t}_{i} ,$$
the likelihood function, which uses the field reliability test data as a sample, is:
$$L ( D \vert k , λ ) = {k}^{m} {λ}^{- m k} {U}^{k - 1} {e}^{( \frac{{X}^{( k )}}{{λ}^{k}} )} \qquad ( 8 )$$
where, D is the field reliability test data;
according to Bayes theory, the joint posterior distributions of k and λ are obtained by combining equations. (2), (6), (7) and (8):
$$π ( k , λ \vert D ) = \frac{{k}^{m + 1} {τ}^{k a} {λ}^{- ( m + a ) k - 1} {U}^{k - 1} {e}^{( - \frac{{X}^{( k )} + b {τ}^{k}}{{λ}^{k}} )}}{Γ ( m + a ) I ( D )} \qquad ( 9 )$$
where, I(D) is:
$$I ( D ) = {\int }_{K} \frac{{k}^{m} {τ}^{k a} {U}^{k - 1}}{{( {X}^{( k )} + b {τ}^{k} )}^{( m + a )}} d k , k ∈ K \qquad ( 10 )$$
combining equations. (1) and (9), the posterior distribution of the reliability R of the known field reliability test data is:
$$\begin{matrix}π ( R \vert D ) = \frac{1}{Γ ( m + a ) I ( D )} \frac{{[ ln ( \frac{1}{R} ) ]}^{a + m - 1}}{R} {\int }_{K} \frac{{k}^{m} {τ}^{ka} {U}^{k - 1} {R}^{\frac{( {X}^{( k )} + b {τ}^{k} )}{{τ}^{k}}}}{{τ}^{k ( m + a )}} dk , & ( 11 ) \\ k ∈ K & \end{matrix}$$
then, the expected value is calculated by equation (11), while the mean reliability is obtained as:
$$\begin{matrix}E ( {R}_{τ} ) = {\int }_{0}^{1} {R}_{τ} \times π ( {R}_{τ} \vert D ) d R = \frac{1}{I ( D )} {\int }_{K} \frac{{k}^{m} {τ}^{ka} {U}^{k - 1}}{{[ {X}^{( k )} + ( b + 1 ) {τ}^{k} ]}^{( m + a )}} dk , & ( 12 ) \\ k ∈ K & \end{matrix}$$
(5) establishment of fault tree model for CNC machine tools
the CNC machine tool is regarded as a complex system, composed of CNC system, servo system, spindle system, feed axis system, cooling and lubrication system, motor and power supply; based on the series-parallel relationship among the subsystems and the influence of subsystems on the machine tool system, the fault tree model is established, regarding the fault event of CNC machine tool as the top event;
(6) calculation of reliability of CNC machine tools
by replacing the “AND gate” with “OR gate” and the “OR gate” with “AND gate” in the fault tree model, and the occurrence of all events is changed into non-occurring, the success tree of the CNC machine tool is obtained;
only normal and failure states are considered for all events, and steady-state processing is treated without considering the time variation;
the minimum path set of reliable tree is Kᵢ(X) and its structural formula is:
$${K}_{i} ( X ) = 1 - {\prod }_{j ⊆ {k}_{i}}^{ } ( 1 - {X}_{j} ) \qquad ( 13 )$$
where, kᵢ is a subscript set of basic events, included in the minimum path set Kᵢ(X);
the structural formula of the top event, represented by the minimum path set is:
$$T = {\prod }_{i} {K}_{i} ( X ) \qquad ( 14 )$$
by substituting reliability into the formula, the reliability calculation equation of CNC machine tools is obtained as:
$$E ( {R}_{τ}^{T} ) = {\prod }_{i} ( 1 - {\prod }_{j ⊆ {k}_{i}} ( 1 - {E}_{j} ( {R}_{τ}^{j} ) ) ) \qquad ( 15 )$$
where E(R^{T}_{τ}) is the mathematical expectation of the reliability of CNC machine tools, and Eⱼ(R^{j}_{τ}) is the mathematical expectation of the reliability of the j^{th} subsystem;
furthermore, the reliability of the CNC machine tool is obtained by the calculation of reliability, as expressed by equation (15).
